(19) United States
(12) Patent Application Publication
(10) Pub. No.: US 2014/0157199 A1
(43) Pub. Date: Jun. 5, 2014

(54) Systems and Methods for Collecting Information with a Mobile Device and Delivering Advertisements Based on the Collected Information

(71) Applicant: QRIOUSLY, INC., Tucson, AZ (US)

(72) Inventors: Christopher Kahler, Bad Kleinkirchheim (AT); Abraham Mueller, Grunbach (AT); Gerald Mueller, Klagenfurt (AT)

(73) Assignee: QRIOUSLY, INC., Tucson, AZ (US)

(21) Appl. No.: 13/706,084

(22) Filed: Dec. 5, 2012

(51) Int. Cl. G06Q 30/02; G06F 3/0482; G06F 3/01; G06F 3/0484

(52) U.S. Cl. CPC G06Q 30/0255; G06F 3/017; G06F 3/04847; G06F 3/0482
USPC 715/833; 705/14.53; 715/863; 715/810

(57) ABSTRACT

In one example embodiment, an information processing system transmits, to a mobile device having a window, question data representative of a question. For an application program, in this example, the mobile device displays the question in the window. For the application program, the information processing system may receive, from the mobile device, answer data representative of an answer to the question. Based on the answer data representative of the answer to the question, the information processing system selects advertisement data representative of an advertisement. In response to the advertisement data being selected, the information processing system transmits, to the mobile device, the advertisement data representative of the first advertisement. For the application program, the mobile device displays the advertisement in a second window of the mobile device.

### BACKGROUND

Businesses have a need to market their products and services to potential customers. The benefits of advertising include brand development, consumer outreach and increased sales. The relevancy of advertising may depend on the perspective of the user. Conventional advertising methods include billboards, flyers that are mailed, and flyers found at stores. Some advertising may also be emailed to a user or displayed on a website. Such advertisements may be considered an annoyance or may be welcomed depending on the perspective of the user.

Because the revenue generated by an advertising campaign is unknown prior to the campaign launch, advertisers undertake a risk that the benefit of advertising may fail to offset the cost. As a response to advertising risk, advertisers often attempt to increase advertising effectiveness by flooding the market with advertisements in an attempt to reach a greater audience. However, flooding the market with poorly targeted advertisements can lead to consumer annoyance and decreased consumer sensitivity.

Accordingly, a need exists for further development of advertising.

### SUMMARY

In some embodiments, an information processing system stores (a) question data representative of a question; (b) first advertisement data representative of a first advertisement; (c) second advertisement data representative of a second advertisement; and (d) instructions executable by a processor. The information processing system may transmit, to a mobile device, the question data representative of the question. In this example, for an application program, the mobile device displays the question in a window of the mobile device. From the mobile device, answer data representative of an answer to the question is received. Based on the answer data representative of the answer to the question, the information processing system may select one of (i) the first advertisement data representative of the first advertisement; and (ii) the second advertisement data representative of the second advertisement. In response to the first advertisement data being selected, the information processing system transmits, to the mobile device, the first advertisement data representative of the first advertisement. For the application program, the mobile device displays the first advertisement in a second window of the mobile device. In response to the second advertisement data being selected, the information processing system transmits, to the mobile device, the second advertisement data representative of the second advertisement. For the application program, the mobile device displays the second advertisement in the second window of the mobile.

In some embodiments, the question data representative of the question includes question data representative of a single question. In some embodiments, the question data representative of the question includes question data representative of a brand question.

In some embodiments, the information processing system displays the brand question after the mobile device displays a predetermined number of questions.

In some embodiments, the information processing system enables a user to customize answer choice data for the question.

In some embodiments, the information processing system embeds a question module into the application program to facilitate the displaying of the questions.

In some embodiments, the information processing system the second window is different from the first window.

In some embodiments, the information processing system determines and displays data representative of at least one of: (a) an amount of questions displayed by the mobile device; (b) an amount of questions answered; (c) an amount of advertisements displayed by the mobile device; and (d) an amount of advertisements selected.

In some embodiments, the information processing system enables a user to change the questions.

In some embodiments, the information processing system determines which question to transmit to the mobile device based on the type of mobile device.

In some embodiments, the information processing system determines which question to transmit to the mobile device based on an answer to a previously displayed question.

In some embodiments, the information processing system determines which question to transmit to the mobile device based on a user profile which is associated with a user of the mobile device.

In some embodiments, the mobile device receives, from an information processing system, question data representative of a question. For an application program, the mobile device causes the display device to display the question in a first window. The mobile device enables a user to operate an input device to answer the question and transmits, to the information processing system, answer data representative of an answer to the question. The mobile device may receive, from the information processing system, advertisement data representative of an advertisement. The advertisement data may be selected based on answer data representative of an answer to the question. The mobile device may display the advertisement in a second window.

In some embodiments, the mobile device enables a user to answer the question by moving a slider to one a plurality or displayed answer choices.

In some embodiments, the mobile device enables a user to answer the question by selecting one of a plurality of displayed answer choices.

In some embodiments, the mobile device simultaneously displays the application program and the question.

Additional features and advantages are described herein, and will be apparent from the following Detailed Description and figures.

### BRIEF DESCRIPTION OF THE FIGURES

FIG. 1 is a high level block diagram of an example network communicating system, according to an example embodiment of the present disclosure.

FIG. 2 is a detailed block diagram showing an example of a computing device, according to an example embodiment of the present disclosure.

FIG. 3 is a block diagram showing an example network structure, according to an example embodiment of the present disclosure.

FIG. 4 includes a flowchart illustrating an example process which, for an application that is executable by a mobile device, displays questions and selects advertisements based on answers to the displayed questions, according to an example embodiment of the present disclosure.

FIG. 5 is a block diagram showing an example data architecture, according to an example embodiment of the present disclosure.

FIGS. 6A, 6B, 6C, 6D, 6E, 6F and 6G are front views an example mobile device, illustrating example questions being displayed in windows, according to an example embodiment of the present disclosure.

FIG. 7 is an example screen shot showing an example interface which enables a user to customize questions and answers to be displayed on a mobile device, according to an example embodiment of the present disclosure.

FIG. 8 is an example screen shot showing data representative of amounts of questions displayed by mobile devices, questions answered, advertisements displayed by mobile devices and advertisements clicked.

FIG. 9 is a front view of an example display of an example information processing system, illustrating a plurality of selectable campaigns and statuses for an entity.

FIG. 10 is example screen shot showing an example map which indicates an amount of questions which were displayed by a mobile device based on each state of the United States.

FIGS. 11A, 11B, 11C, 11D, 11E and 11F are example screen shots showing an example form used to create new questions including a brand question, according to an example embodiment of the present disclosure.

### DETAILED DESCRIPTION

The present disclosure relates in general to a system for causing a mobile device to display questions for an application executed by the mobile device. Briefly, in an example embodiment, the questions are dynamically displayed via a question module that is embedded into code of an application (e.g., source code) downloaded by the mobile device. In one example, the question module operates with an input device of the mobile device to enables a user to answer questions by moving a slider to one of a plurality of answers. The answers may be collected for the user, and targeted advertisements may be selected based the user's answers. The presently disclosed system may advantageously allow for application publishers to determine insights from there application audience, including insights such as demographics, psychographics and brand preferences. The presently disclosed system may also advantageously allow for application publishers to determine which advertisements are more effective than others. For example, after a predetermined amount of time since the display of a designated advertisement, a user may be asked to identify the subject matter of the advertisement previously displayed.

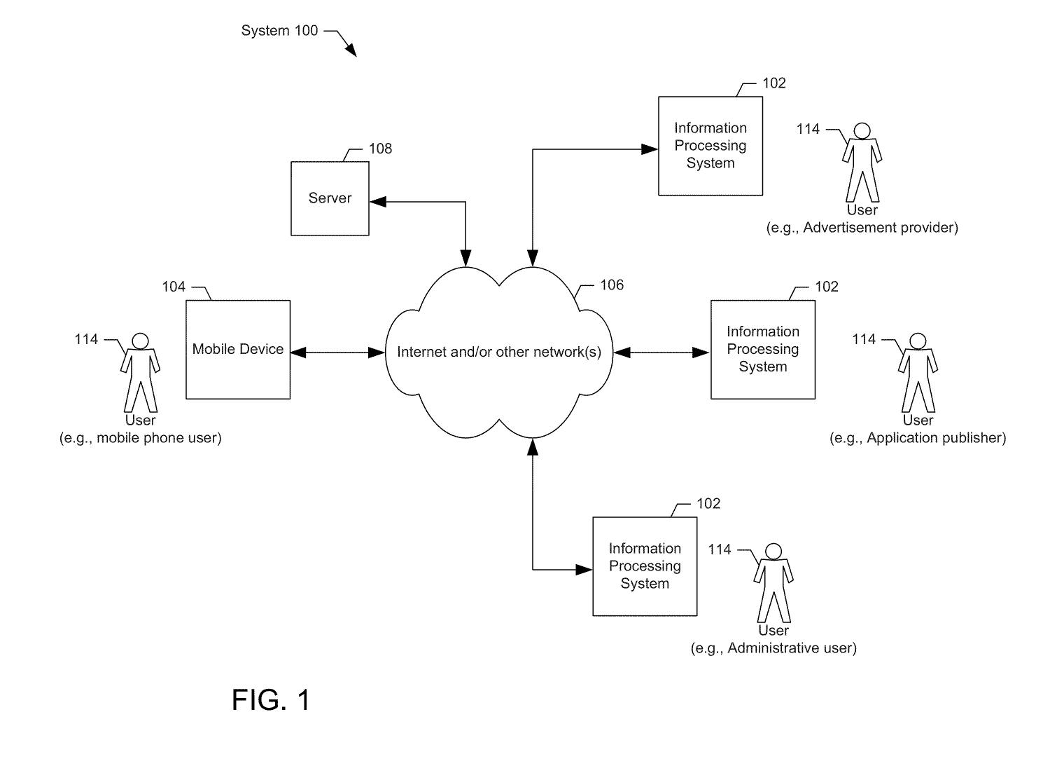

The present system may be readily realized in a network communications system. A high level block diagram of an example network communications system 100 (“system 100”) is illustrated in FIG. 1. In this example, system 100 includes at least one mobile device 104 and at least one information processing system 102. System 100 may include a variety of mobile devices 102 which typically include a user display for providing information to users and various interface elements as will be discussed in further detail below.

Mobile device 104 may include a cellular phone, a personal digital assistant, a laptop computer, a tablet computer, a smart phone. In some embodiments, mobile device 103 may include any mobile digital devices such as Apple Inc.'s iPhone™, iPod Touch™, and iPad™ Further, mobile device 103 may include smart phones based on Google Inc.'s Android™, Nokia Corporation's Symbian™ or Microsoft Corporation's Windows Mobile™ operating systems, and Research In Motion Limited's Blackberry™ etc. Mobile device 103 is preferably configured to download, install and execute various application programs.

Mobile device 104 may communicate with the information processing system 102 via a connection to one or more communications channels 106 such as the Internet or some other data network, including, but not limited to, any suitable wide area network or local area network. It should be appreciated that any of the devices and systems described herein may be directly connected to each other instead of over a network. At least one server 108 may be part of network communications system 100, and may communicate with information processing system 102 and mobile device 104.

Information processing system 102 may interact with a large number of users at a plurality of different mobile devices 102. Accordingly, information processing system 102 is typically a high end computer with a large storage capacity, one or more fast microprocessors, and one or more high speed network connections. Conversely, relative to a typical information processing system 102, each mobile device 104 may include less storage capacity, a single microprocessor, and a single network connection.

It should be appreciated that users as described herein may include any person or entity which uses the presently disclosed system and may include a wide variety of parties. For example, the users described herein may refer to various different entities, including application publishers, advertisement providers, administrative users, mobile device users, private individuals, commercial partners and/or editorial partners.

Typically, information processing system 102 and/or servers 108 may store files, programs, databases, and/or web pages in memories for use by mobile devices 102, and/or other information processing systems 104 or servers 108.

Information processing system 102 and/or server 108 may be configured according to its particular operating system, applications, memory, hardware, etc., and may provide various options for managing the execution of the programs and applications, as well as various administrative tasks. Information processing system 102 and/or server 108 may interact via at least one network with at least one other information processing system 102 and/or server 108, which may be operated independently. Information processing systems 104 and servers 108 operated by separate and distinct entities may interact together according to some agreed upon protocol.

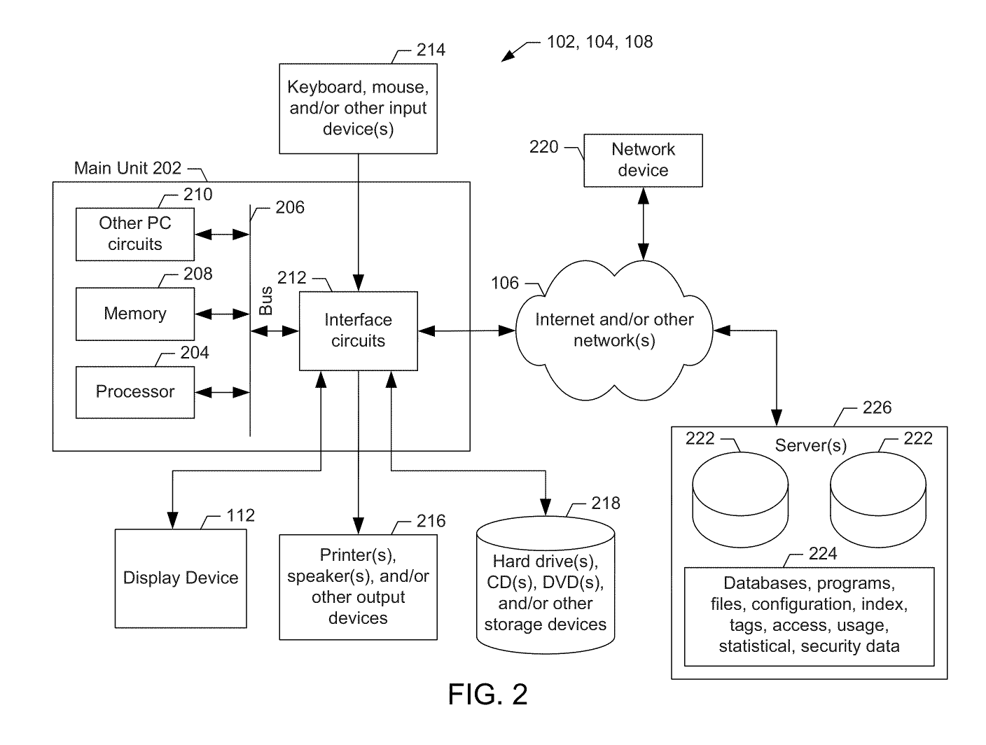

A detailed block diagram of the electrical systems of an example computing device is illustrated in FIG. 2. The example computing device may include any of devices and systems described herein, including mobile device 104, information processing system 102 and server 108. In this example, the example computing devices may include main unit 202 which preferably includes at least one processor 204 electrically connected by address/data bus 206 to at least one memory device 208, other computer circuitry 210, and at least one interface circuit 212. Processor 204 may be any suitable processor, such as a microprocessor from the INTEL° PENTIUM® family of microprocessors. Processor 204 may include one or more microprocessors, central processing units (CPUs), computing devices, microcontrollers, digital signal processors, or like devices or any combination thereof. Memory 208 preferably includes volatile memory and non-volatile memory. Preferably, memory 208 stores software program(s) that interact with the other devices in system 100 as described below. This program may be executed by processor 204 in any suitable manner. In an example embodiment, memory 208 may be part of a “cloud” such that cloud computing may be utilized by mobile device 104, information processing system 102 and server 108. Memory 208 may also store digital data indicative of documents, files, programs, web pages, etc. retrieved from computing devices 102, 103 and 104 and/or loaded via input device 214.

Interface circuit 212 may be implemented using any suitable interface standard, such as an Ethernet interface and/or a Universal Serial Bus (USB) interface. At least one input device 214 may be connected to interface circuit 212 for entering data and commands into main unit 202. For example, input device 214 may be at least one of a keyboard, mouse, touch screen, track pad, track ball, isopoint, image sensor, character recognition, barcode scanner, and a voice recognition system.

As illustrated in FIG. 2, at least one display device 112, printers, speakers, and/or other output devices 216 may also be connected to main unit 202 via interface circuit 212. Display device 112 may be a cathode ray tube (CRTs), a liquid crystal display (LCD), or any other suitable type of display device. Display device 112 may be configured to generate visual displays during operation of mobile device 104, information processing system 102 and/or server 108. For example, display device 112 may provide a user interface, which will be described in further detail below, and may display at least one web page received from mobile device 104, information processing system 102 and/or server 108. A user interface may include prompts for human input from user 114 including links, buttons, tabs, checkboxes, thumbnails, text fields, drop down boxes, etc., and may provide various outputs in response to the user inputs, such as text, still images, videos, audio, and animations.

At least one storage device 218 may also be connected to main unit 202 via interface circuit 212. At least one storage device 218 may include at least one of a hard drive, CD drive, DVD drive, and other storage devices. At least one storage device 218 may store any type of data, such user data, mobile device data, operations data, inventory data, image data, video data, audio data, tagging data, historical access or usage data, statistical data, security data, etc., which may be used by mobile device 104, information processing system 102 and/or server 108.

Mobile device 104, information processing system 102 and/or server 108 may also exchange data with other network devices 220 via a connection to network 106. Network devices 220 may include at least one server 226, which may be used to store certain types of data, and particularly large volumes of data which may be stored in at least one data repository 222. Server 226 may include any kind of data 224 including databases, programs, files, libraries, pricing data, user data, mobile device data, operations data, inventory data, image data, video data, audio data, tagging data, historical access or usage data, statistical data, security data, etc. Server 226 may store and operate various applications relating to receiving, transmitting, processing, and storing the large volumes of data. It should be appreciated that various configurations of at least one server 226 may be used to support and maintain system 100. In some embodiments, server 226 is operated by various different entities, including application publishers, advertisement providers, private individuals, administrative users, commercial partners and/or editorial partners. Also, certain data may be stored in of mobile device 104, information processing system 102 and/or server 108 which is also stored on server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to of mobile device 104, information processing system 102 and/or server 108 can be controlled by appropriate security software or security measures. A user's access can be defined by of mobile device 104, information processing system 102 and/or server 108 and limited to certain data and/or actions. Accordingly, users of system 100 may be required to register with of mobile device 104, information processing system 102 and/or server 108.

As noted previously, various options for managing data located within of mobile device 104, information processing system 102 and/or server 108 and/or in server 226 may be implemented. A management system may manage security of data and accomplish various tasks such as facilitating a data backup process. The management system may update, store, and back up data locally and/or remotely. A management system may remotely store data using any suitable method of data transmission, such as via the Internet and/or other networks 106.

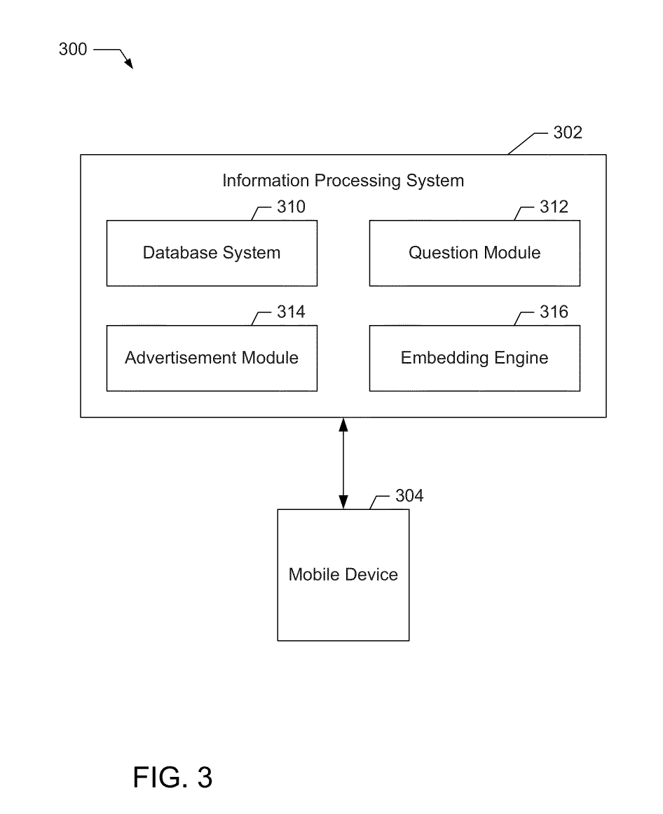

FIG. 3 is a block diagram showing an example network structure 300. In this example, network structure 300 includes information processing system 302 which is in communication with mobile device 304. As described above, in some embodiment, information processing system 302 is operated by an entity such an application publisher. It should be appreciated that information processing system 302 and mobile device 304 illustrated in FIG. 3 may be implemented as information processing system 102 and mobile device 104.

As illustrated in FIG. 3, in this example, information processing system 302 may include database system 310, question module 312, advertisement module 314 and embedding module 316. Question module 312, advertisement module 314 and embedding engine 316 may include software and/or hardware components, such as a field programmable gate array (FPGA) or an application specific integrated circuit (ASIC), which performs certain tasks. Question module 312, advertisement module 314 and embedding engine 316 may advantageously be configured to reside on an addressable storage medium and configured to execute on one or more processors. Thus, question module 312, advertisement module 314 and embedding engine 316 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Database system 310 may include a wide variety of data. For example, database system may include any of the following data: databases, programs, files, libraries, pricing data, user data, mobile device data, operations data, inventory data, image data, video data, audio data, tagging data, historical access or usage data, statistical data, security data, different groups of application associated with different publishers, and user profile data. In one example embodiment, database system 310 includes applications which may be downloaded or requested by a mobile device.

Question module 312 may be configured to determine or select question data representative of at least one question based on any suitable criteria. For example, question module 312 may be configured to select question data based on a user profile which includes answer data representative of answers to questions previously served to a user of a mobile device. In some embodiments, question module 312 randomly selects question data representative of a question to be displayed by a mobile device. In some embodiments, question module 312 causes the questions to be displayed by the mobile device at a designated window. The window may be, for example, rectangular-shaped and positioned at the bottom of a display screen of the mobile device.

In some embodiments, data associated with a mobile device that requests content with respect to which question module 312 is invoked are included as with a request for a question to information processing system 302 so that a more relevant and targeted question can be selected from the database system 310.

As described further below, data that may be available from information processing system 302 includes data such as user data 508, mobile device data 510, other data 512, content data 514, statistical data 516 and historical data 518.

In some embodiments, question module 312 access data from database system 310 to determine which question to select.

In some embodiments, advertisement module 314 is configured to determine or select advertisement data representative of at least one advertisement based any suitable criteria. For example, advertisement module 314 may select advertisement data representative of at least one advertisement based on a user profile including answer data to questions previously served to a user of a mobile device.

In some embodiments, embedding engine 316 is configured to embed question module 312 into the source code of an application that is executable by a mobile device. In some embodiments, embedding engine 316 is configured to embed advertisement module 314 into the source code of an application that is executable by a mobile device.

Although the above has been shown using information processing system 302 and mobile device 304, there can be many alternatives, modifications, and variations. For example, some of the modules of the information processing system may be expanded and/or combined. Further, the functions provided by the advertisement module may be employed by a separate information processing system, such as an advertisement provider system operated by a separate entity. In one example, information processing system 302 does not include database system 310. In this example, information processing system 302 does not include database system 310 may be configured to communicate with the separate database system 310. Other systems may be inserted to those noted above. Depending upon the embodiment, the database system 310, question module 312, advertisement module 314 and embedding engine 316 may be replaced. Further details of these systems are found throughout the present specification.

Information processing system 302 may process data received by mobile device 304 as well as other devices. For example, another computing device (e.g., a personal computer) may query data from database system 310 for use in a report, for selecting a question and/or for selecting an advertisement.

It should also be appreciated that certain modules of the mobile device may be considered to be part of information processing system 302, however, for discussion purposes, any modules and any engines of the mobile device are referred to as separate from information processing system 302.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

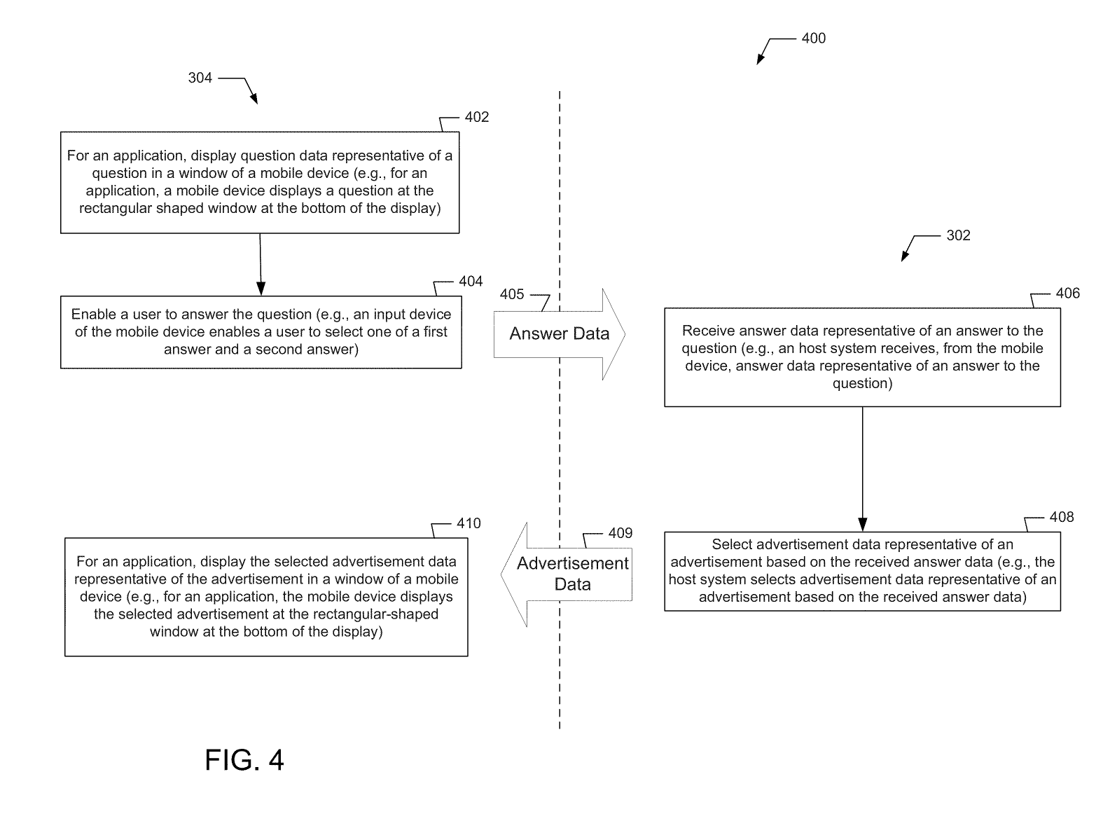

As illustrated in FIG. 4, a flowchart of an example process 400 includes displaying questions and selecting advertisements based on answers to the displayed questions for an application which is executable by a mobile device. Preferably, process 400 is embodied in one or more software programs which are stored in one or more memories and executed by one or more processors. Although process 400 is described with reference to the flowchart illustrated in FIG. 4, it should be appreciated that many other methods of performing the acts associated with process 400 may be used. For example, the order of many of the steps may be changed, some of the steps described may be optional, and additional steps may be included. As shown in FIG. 4, data may flow between mobile device 304 and information processing system 302.

More specifically, in one example embodiment, for an application, question data representative of a question is displayed in a window of a mobile device, as indicated by block 402. In some example embodiments, information processing system 302 controls which question is displayed by mobile device 304 in real time or in near real time. Information processing system 302 may start, pause and/or deactivate the display of a question by mobile device 304. In some embodiments, information processing system 302 may start, pause and/or deactivate the display of the question by mobile device 304, regardless of whether the mobile device is presently running the application. In some embodiments, mobile device 304 must be running an application while the question is being displayed for that application. In some embodiments, the mobile device displays a question in a rectangular-shaped window positioned at the bottom of the display screen of the display device. In some embodiments, the mobile device replaces advertisements previously displayed by the mobile device with questions. That is, instead of displaying advertisements, the mobile device displays at least one question.

As indicated by block 404, in this example embodiment, a user is enabled to answer the displayed question. In one embodiment, the mobile device enables a user to select an answer to the displayed question via an input device. In one embodiment, where a mobile device includes a touch screen, the mobile device may enable a user to select an answer using a touch gesture. For example, the mobile device may enable a user to select an answer by moving a displayed slider to one of a plurality of displayed answers. In one embodiment, the mobile device may enable a user to answer the question by entering text using a displayed text input box. In some embodiments, the mobile device enables a user to answer a question using a physical gesture. For example, the mobile device may enable a user to select an answer (e.g., “yes”) by shaking the mobile device.

In response to a user answering the question, mobile device 304 may transmit answer data to information processing system 302 as indicated by arrow 405. In some embodiments, mobile device 304 may transmit answer data to information processing system 302 using any suitable existing cellular telephone infrastructure.

As indicated by block 406, in this example embodiment, answer data representative of an answer to the question may be received. For example, information processing system 302 may be configured to receive and store answer data that was transmitted from a mobile device.

As indicated by block 408, advertisement data representative of an advertisement may be selected based on answer data representative of an answer to the question. In one embodiment, information processing system 302 selects advertisement data based on received answer data. In another embodiment, mobile device 304 selects the advertisement data based on answer data.

In response to advertisement data being selected, information processing system 302 may transmit advertisement data to mobile device 304 as indicated by arrow 409. In some embodiments, information processing system 302 may transmit advertisement data to mobile device 304 using any suitable existing cellular telephone infrastructure.

As indicated by block 410, in one example embodiment, for an application, the selected advertisement data representative of the advertisement may be displayed in a window of a mobile device. In one embodiment, for an application, the mobile device displays the selected advertisement at a rectangular shaped window at the bottom of the display of the mobile device. In one embodiment, the mobile device which displays such advertisement is the same mobile device which previously displayed a question. In one embodiment, the mobile device which displays such advertisement is a different mobile device which previously displayed a question.

In some embodiments, the mobile device enables the user to select the displayed advertisement. In these embodiments, in response to the displayed advertisement being selected, the mobile device may display an offer.

In some embodiments, in response to the mobile device requesting or downloading an application from information processing system 302, information processing system 302 transmits the requested application along with question data to be displayed by the mobile device. In this example, the question data may be embedded into the application before the application is downloaded by the user device. In one example, the question data may be embedded into the application in response to an application already store on the mobile device being updated.

In some embodiments, information processing apparatus 302 may dynamically provide questions to mobile device 304. For example, in one embodiment, question module 302 or a function call to question module 302 may be embedded in the source code of an application. In this example, in response to a user request for an application having the embedded module, the application having the embedded module is transmitted and stored by the mobile device. Thereafter, in this example, question module 302 or the function to call to question module 302 may be dynamically invoked to obtain question data from database system 310. In response to a request from the mobile device for a question, question data may be selected and transmitted from the information processing system to the mobile device having the embedded module.

In some embodiments, mobile device 304 is configured to display questions based on the employment of one or more of the following: a software development kit; Rest API calls; a bidding platform; a mobile web JavaScript snippet.

In one example, network structure 300 includes a second information processing system. In one embodiment, the second information processing system may be operated by a separate entity. In this embodiment, the second information processing system may be configured to deploy at least one database system 310, question module 312, advertisement module 314 and embedding module 316 to information processing system 302. For example, in one embodiment, information processing system 302 may be operated by an application publishing entity which sells applications. In this example, the second information processing system may be configured to distribute at least one database system 310, question module 312, advertisement module 314 and embedding module 316 to information processing system 302. It should be appreciated that the second information processing system can be implemented using any suitable computing device, such as computing devices 102 and 104 discussed above.

In one embodiment, the second information processing system enables information processing system 302 to receive the at least one database system 310, question module 312, advertisement module 314 and embedding module 316 based on the employment of one or more of the following: a software development kit; Rest API calls; a bidding platform; and a mobile web JavaScript snippet.

In some embodiments, information processing system 302 creates a user profile which is associated with a user of a mobile device. In one example embodiment, information processing system 302 is operatively connected to another information processing system that is separate from information processing system 302. The user profile may be stored in database system 310.

In some embodiments, the user profile is associated with or corresponds to a unique identifier (e.g., a Unique Device Identifier).

In some embodiments, information processing system 302 may create or update the user profile based on data representative of answers to questions displayed by the mobile device.

In some embodiments, information processing system 302 may create or update the user profile based on data representative of impressions such as when questions are unanswered by a user of the mobile device.

In some embodiments, information processing system 302 may create or update the user profile based on data representative of which advertisements have already been displayed by the user's mobile device.

In some embodiments, information processing system 302 may create or update the user profile based on data representative of which displayed advertisements have been selected or clicked by a user of the mobile device.

In some embodiments, information processing system 302 creates the user profile by including or collecting data representative of data representative of, but not limited to: a location of the mobile device; the type of mobile device; the operating system of the mobile device; the version of the operating system of the mobile device; the time; the time zone; the language of the mobile device; content of the mobile device (e.g., an application, an application category, a website URL, etc.); keywords describing the content of the mobile device; a partner ID; the available space to display a question; a user agent or any other suitable data. In some embodiments, the information processing system 302 creates or updates the user profile based on data representative of a user's history of any of the foregoing data.

In this example, the separate information processing system is operated by a different entity and is configured to create the user profile. In one embodiment, the mobile device is configured to create the user profile for the user of the mobile device.

In some embodiments, information processing system 302 determines whether to cause a mobile device to display the question data representative of a question in a window. In some embodiments, the determination to cause the mobile device to display the question data representative of a question in a window is determined based on a location of the mobile device, determined based on the type of mobile device, determined based on the operating system of the mobile device, determined based on the version of the operating system of the mobile device, a unique identifier of the mobile device (e.g., a Unique Device Identifier), determined based on time, determined based on a time zone, determined based on language, determined based on content (e.g., an application, an application category, a website URL, etc.), determined based on keywords describing content, determined based on a partner ID, determined based on the available space to display the question, determined based on a user agent determined based on the availability of advertisements, determined based on answer data associated with or corresponding to a user of the mobile device or determined based on any other suitable method or criteria.

In some embodiments, information processing system 302 determines or selects question data representative of at least one question to be displayed. In some embodiments, the determination of which question data representative of at least one question to be displayed is determined based on a location of the mobile device, determined based on the type of mobile device, determined based on the operating system of the mobile device, determined based on the version of the operating system of the mobile device, a unique identifier of the mobile device (e.g., a Unique Device Identifier), determined based on time, determined based on a time zone, determined based on language, determined based on content (e.g., an application, an application category, a website URL, etc.), determined based on keywords describing content, determined based on a partner ID, determined based on the available space to display the question, determined based on a user agent, determined based on the availability of advertisements, determined based on answer data associated with or corresponding to a user of the mobile device or determined based on any other suitable method or criteria.

In some embodiments, information processing system 302 determines when to cause a mobile device to display the question data representative of a question in a window. In some embodiments, the determination of when to cause the mobile device to display the question data representative of a question in a window is determined based on a location of the mobile device, determined based on the type of mobile device, determined based on the operating system of the mobile device, determined based on the version of the operating system of the mobile device, a unique identifier of the mobile device (e.g., a Unique Device Identifier), determined based on time, determined based on a time zone, determined based on language, determined based on content (e.g., an application, an application category, a website URL, etc.), determined based on keywords describing content, determined based on a partner ID, determined based on the available space to display the question, determined based on a user agent, determined based on the availability of advertisements, determined based on answer data associated with or corresponding to a user of the mobile device or determined based on any other suitable method or criteria.

The question may be displayed by the mobile device based on different modes. For example, in one embodiment, as described above, the mobile device may enable a user to move a displayed slider to answer the question. In another example, the mobile device may enable the user to operate an input device of the mobile device to answer the question by clicking a designated button. In another example, the mobile device may enable the user to operate an input device of the display device to enter text to answer the question.

In some embodiments, the question may be presented so as to enable a user to provide a rating. In some embodiments, the question may be presented using at least one of a photo, a video, sound and device sensors.

It should be appreciated that other suitable methods for presenting questions and enable answering questions may be employed.

In some embodiments, the subject of the at least one question displayed by the mobile device may be related to content provided by information processing system 302. In some embodiments, the subject of the at least one question displayed by the mobile device is not related to any content provided by information processing system 302.

As discussed above, in some embodiments, at least one question may be displayed in a window of a mobile device. In some embodiments, the window which displays the question can be described as an area or line displayed at the bottom of an application. In some embodiments, the window can be described as same window which displays the application program.

In some embodiments, the mobile device displays the question at the top of the screen of the display device. In some embodiments, the display device displays the question in a newly displayed window which is separate from the window displayed by the application.

In some embodiments, the mobile device displays the question in a portion of the display screen having a size of 320×50 pixels.

In some embodiments, a third party real time bidding mobile ad network delivers the questions to the mobile device.

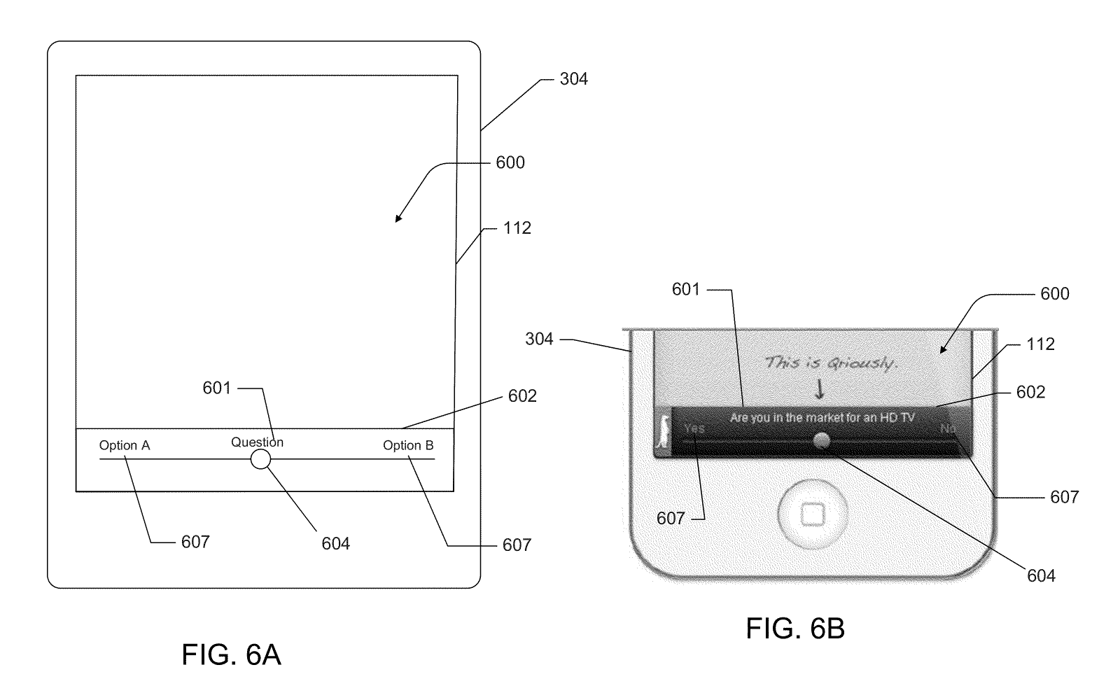

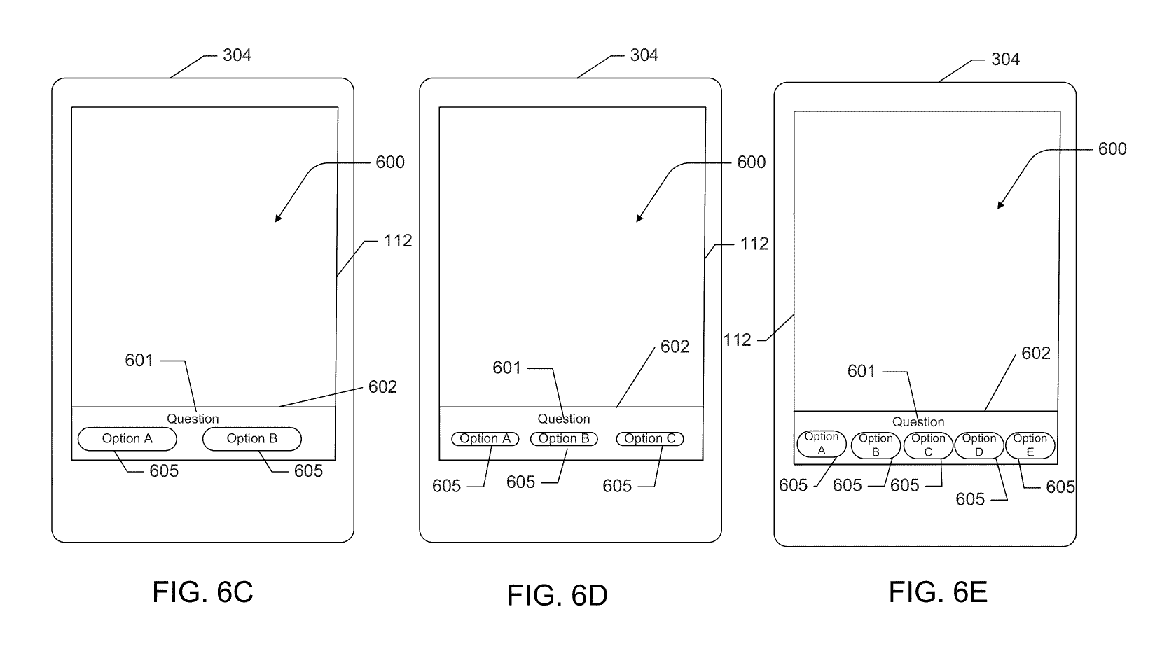

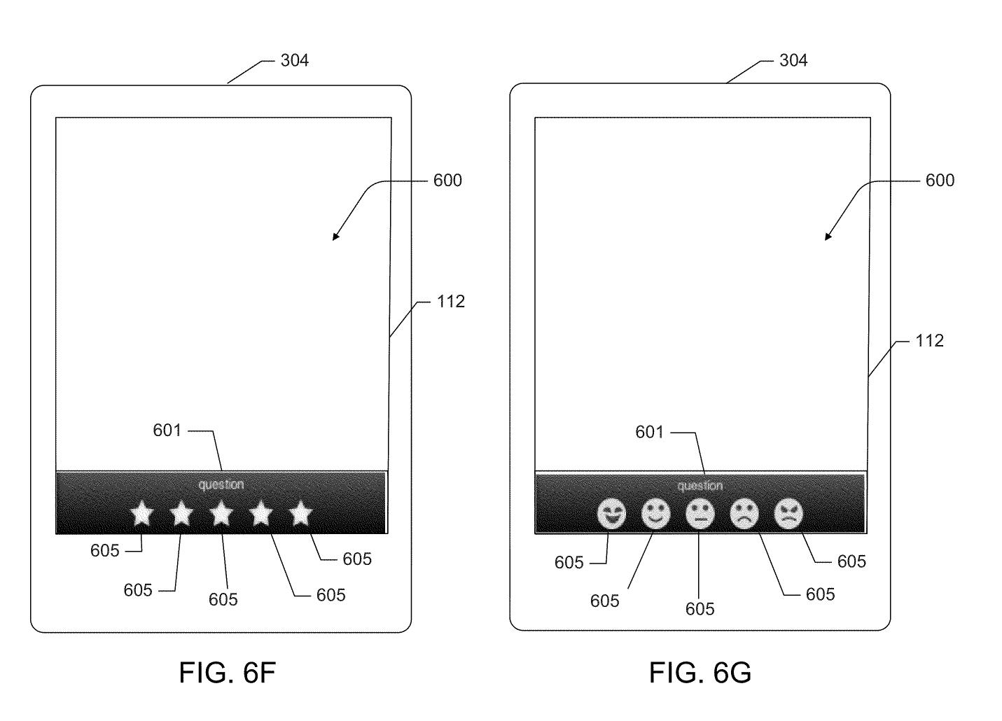

Referring to FIGS. 6A to 6G, these examples generally illustrate some different types or modes of questions which may be displayed by display device 112 of mobile device 304. Such configurations may enable an entity to profile their user's affinity towards purchasing decisions on high-definition televisions, and therefore more relevant advertising may be selected and displayed to the user of the mobile device.

As illustrated in FIG. 6A, display device 112 displays application 600 and question 601 in window 602. In this example, the question module operates with the touch screen of mobile device 304 to enable a user to answer the question by moving slider 604 to one of first answer choice 607 and second answer choice 607. For example, as illustrated in FIG. 6B, display device 112 displays application 600 and question 601. In this example, the question “ARE YOU IN THE MARKET FOR AN HD TV” is provided to the user visually, in rectangular-shaped window 602. In this example, the question module operates with the touch screen of mobile device 304 to enable a user to answer the question by moving slider 604 to one of first answer choice “YES” 607 and second answer choice “NO” 607. It should be appreciated that many other customizable questions may be presented to a user of a mobile device. By way of example, the following questions may be provided (visually or through suitable audio or audiovisual displays) to a user of a mobile device: “DO YOU SHOP ONLINE?”; “WHAT IS YOUR POLITICAL AFFILIATION?”; “WOULD YOU PAY FOR THIS APPLICATION?”; “WOULD YOU RECOMMEND THIS APPLICATION TO A FRIEND?”; “ARE YOU MALE OR FEMALE?”; “DO YOU MAKE MORE THAN 100K PER YEAR?”; “DO YOU HAVE A COLLEGE DEGREE?”

In some embodiments, as discussed above, mobile device 304 may enable a user to answer a displayed question by selecting or clicking at least one designated button. For example, as illustrated in FIGS. 6C, 6D and 6E, mobile device 304 enables a user to answer the displayed question by selecting or clicking one of a plurality of answer choices or designated buttons 605. It should be appreciated that the number of answer choices or designated buttons 605 may be customizable. For example, in FIGS. 6C to 6E, mobile device 304 displays two buttons 605, three buttons 605, or five buttons 605, respectively.

In some embodiments, mobile device 304 may enable a user to answer a displayed question based on selecting a displayed rating. For example, in FIG. 6F, mobile device 304 enables a user to answer question 601 based on selecting one of the displayed buttons 605 which correspond to a rating.

In some embodiments, mobile device 304 may enable a user to answer a displayed question based on selecting one of a plurality of displayed faces which may correspond to emotions. For example, in FIG. 6G, mobile device 304 enable a user to answer question 601 based on selecting one of the displayed faces 605 which correspond to emotions.

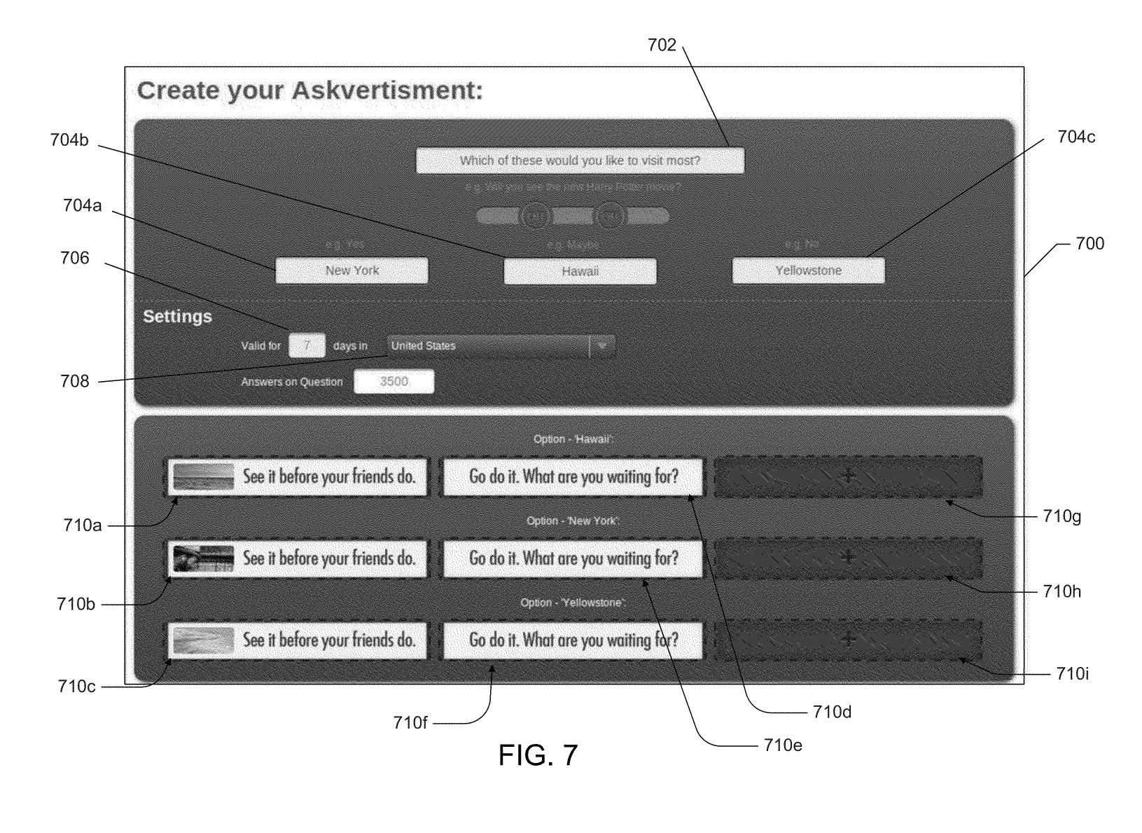

FIG. 7 is an example screen shot 700 showing an example interface employed to enable a user to customize or create questions, answers choices and advertisements.

In this example, information processing system 302 displays question field 702 and answer fields 704a, 704b and 704c.

In some embodiments, question field 702 enables a user to type questions which can be displayed by mobile device 304. In this example, as displayed in question field 702, a user has already typed in the question “Which of these would you like to visit most?”

In some embodiments, answer fields 704a, 704b and 704c enable a user to type answer choices which can be displayed by mobile device 304. In this example, as displayed in answer field 704a, a user has already typed in the answer choice “New York.” As displayed in answer field 704b, a user has already typed in the answer choice “Hawaii.” As displayed in answer filed 704c, a user has already typed in the answer choice “Yellowstone.”

In some embodiments, information processing system 302 enables a user to set how long at least one question will be able to be displayed by a mobile device. For example, as shown in FIG. 7, time meter 706 enables a user to enter an amount of days in which the question displayed in question field 702 will be able to be displayed or selected to be displayed by a mobile device.

In some embodiments, as shown in FIG. 7, information processing system 302 displays drop down menu 708 which enables a user to specify a geographic location in which a designated question may be displayed.

In some embodiments, as shown in FIG. 7, information processing system 302 displays advertisement fields 710a to 710i. In this example, advertisement fields 710a to 710i enable a user to select which advertisements will be displayed by the mobile device based on which answer a user selects using the mobile device.

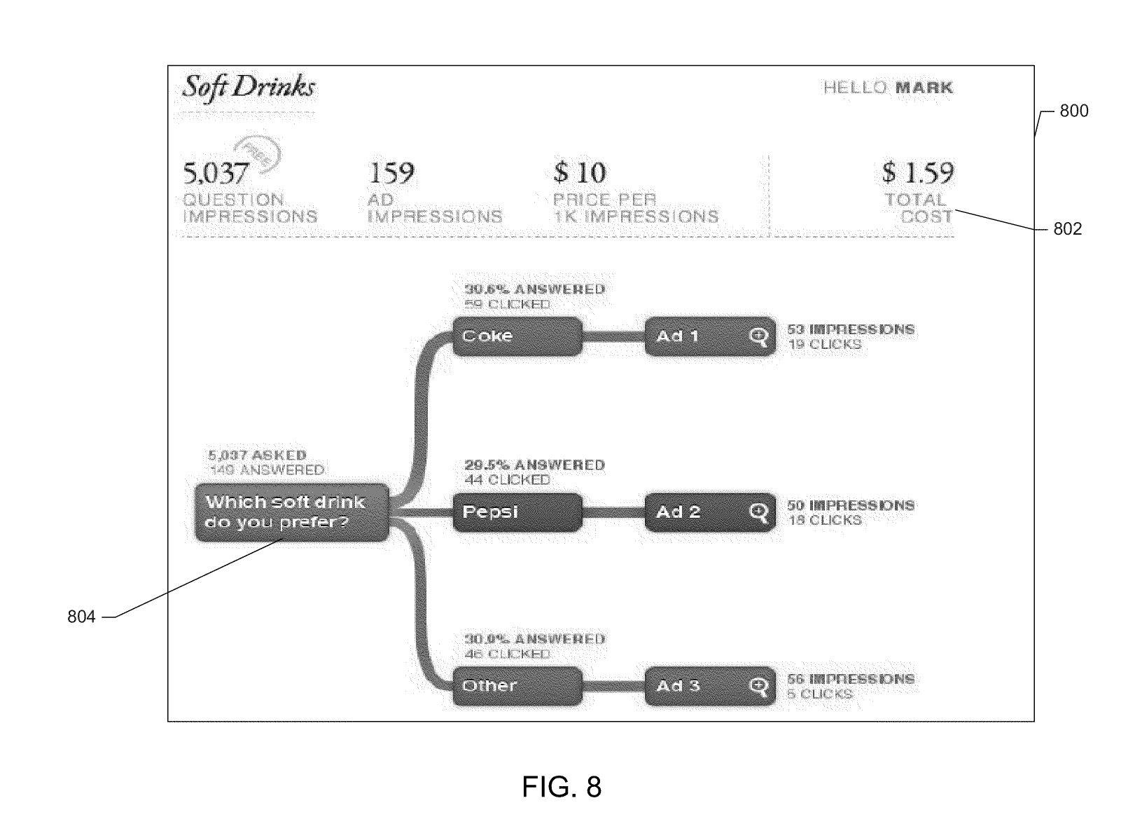

FIG. 8 is an example screen shot 800 showing an example cost 802 for designated question 804. In this example, the cost is calculated based on the total amount of advertisements selected by a user of a mobile device.

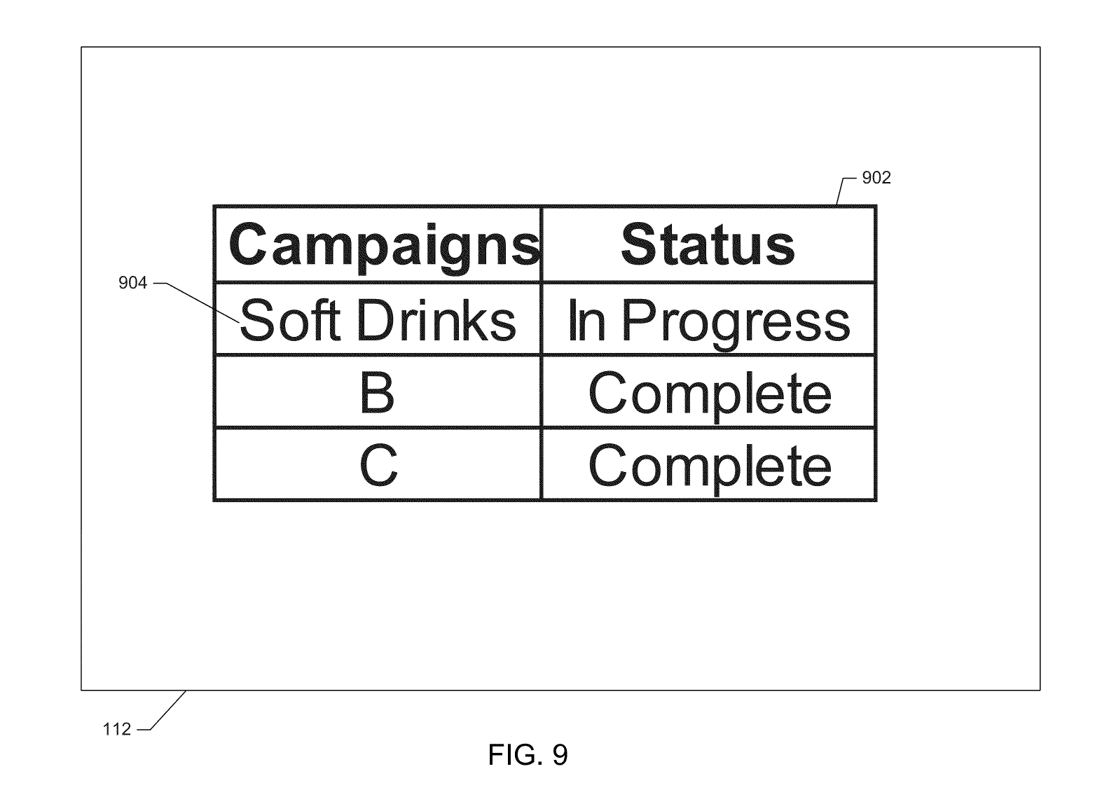

In this example, an entity (e.g., an application publisher) may log into information processing system 302 and select any campaign being handled by the entity in control of information processing system 302. For example, referring to FIG. 9, after logging into information processing system 302, display device 112 may display chart 902. In this example, chart 902 displays each campaign being handled by the entity in control of information processing system 302. In this example, in response to a user selecting the campaign titled “Soft Drinks” 904, information processing system 302, displays information corresponding to the Soft Drinks Campaign, such as the information displayed in FIG. 8.

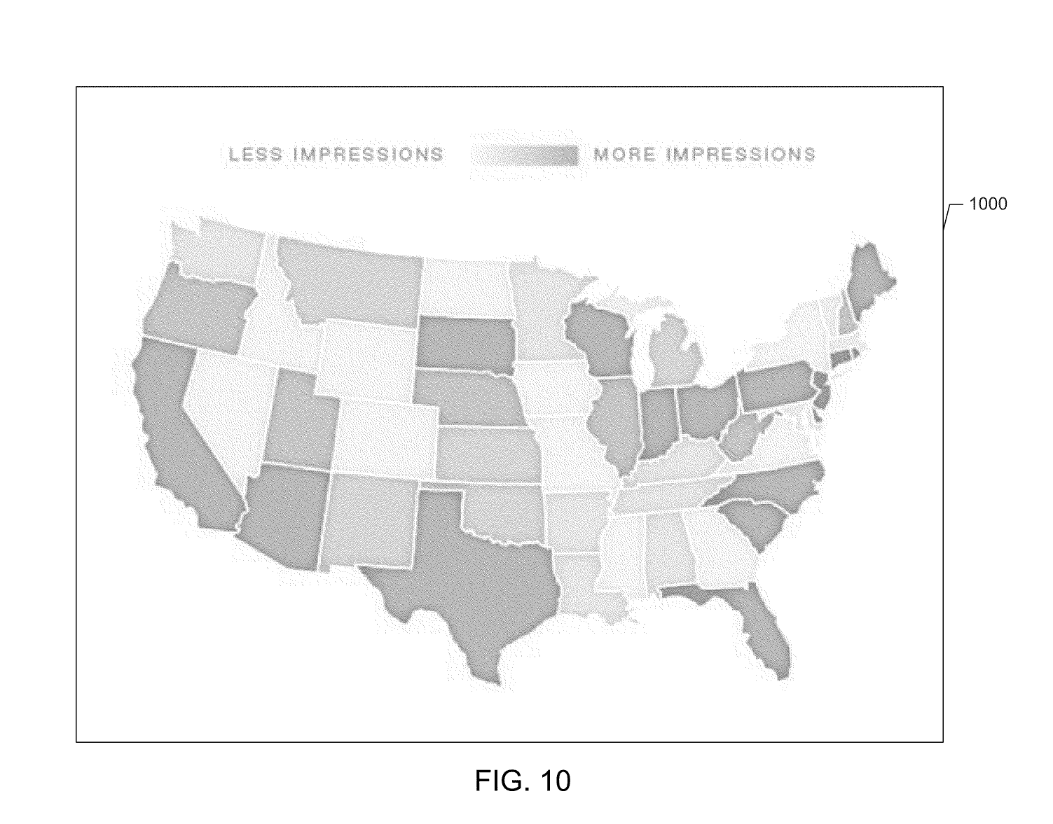

In some embodiments, information processing system 302 displays data indicative of the amount of questions displayed by a mobile device or the amount of advertisements displayed by the mobile device based on geographic locations. For example, FIG. 10 is a screen shot showing an example map which indicates the amount of questions which were displayed by a mobile device based on each state of the United States. In this example, a darker shade is indicative of more questions being displayed by mobile devices in that state.

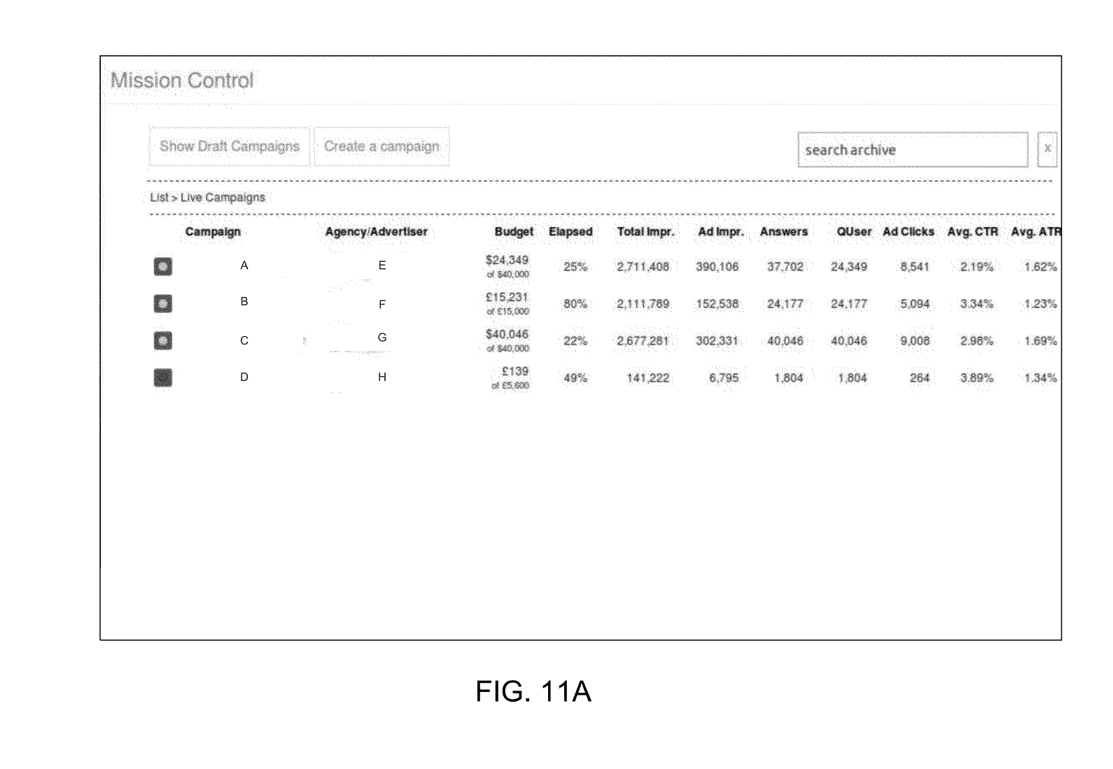

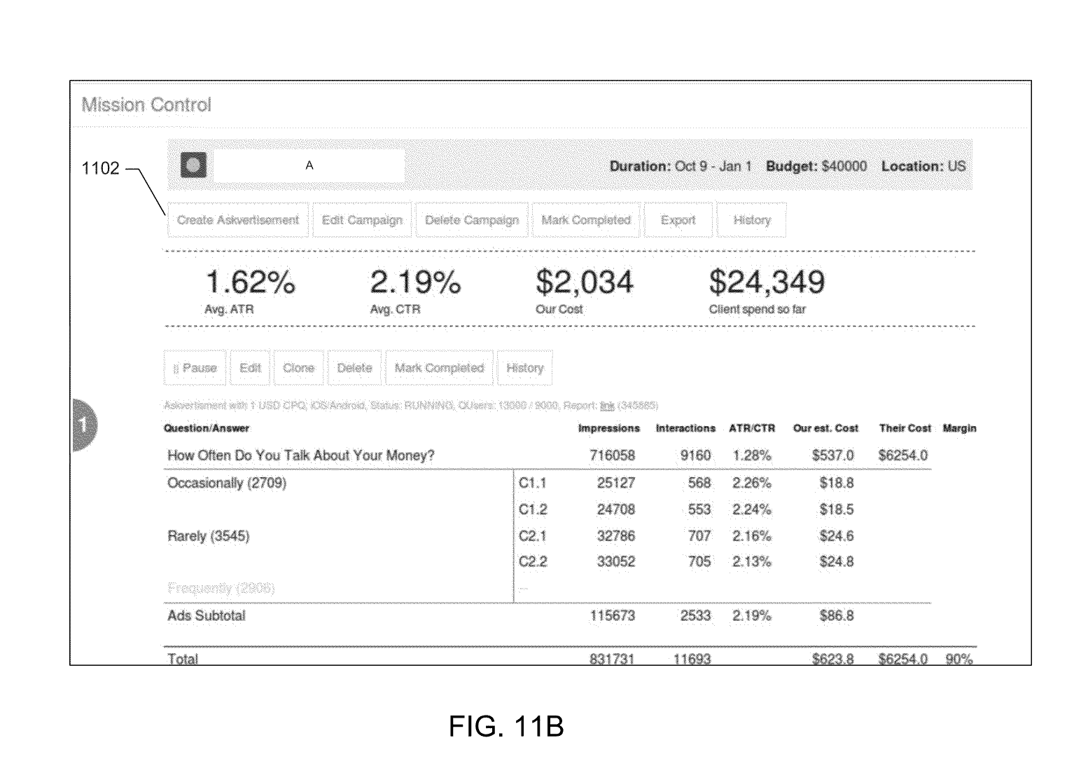

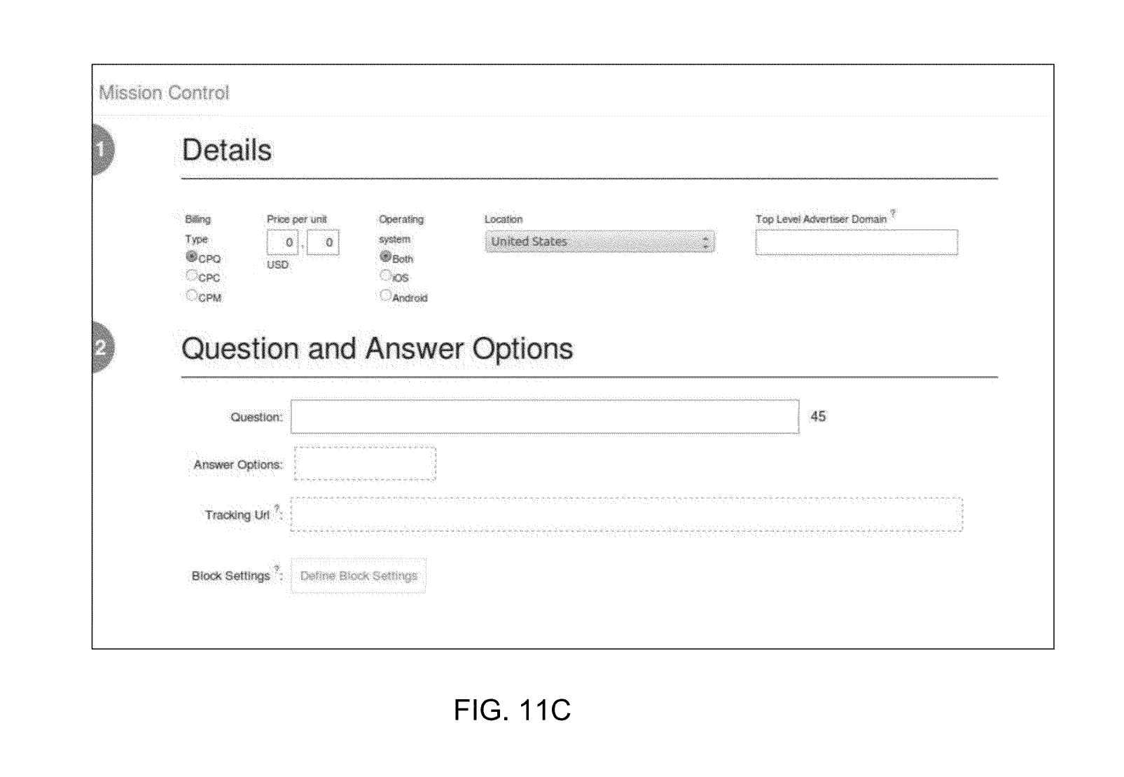

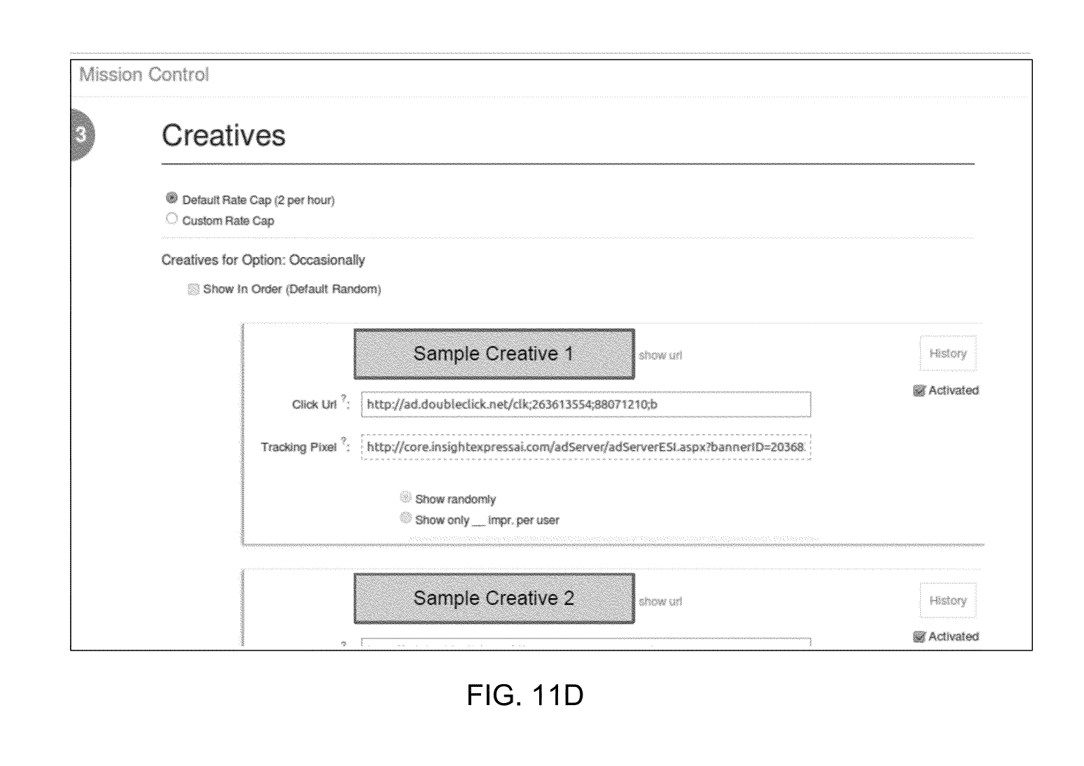

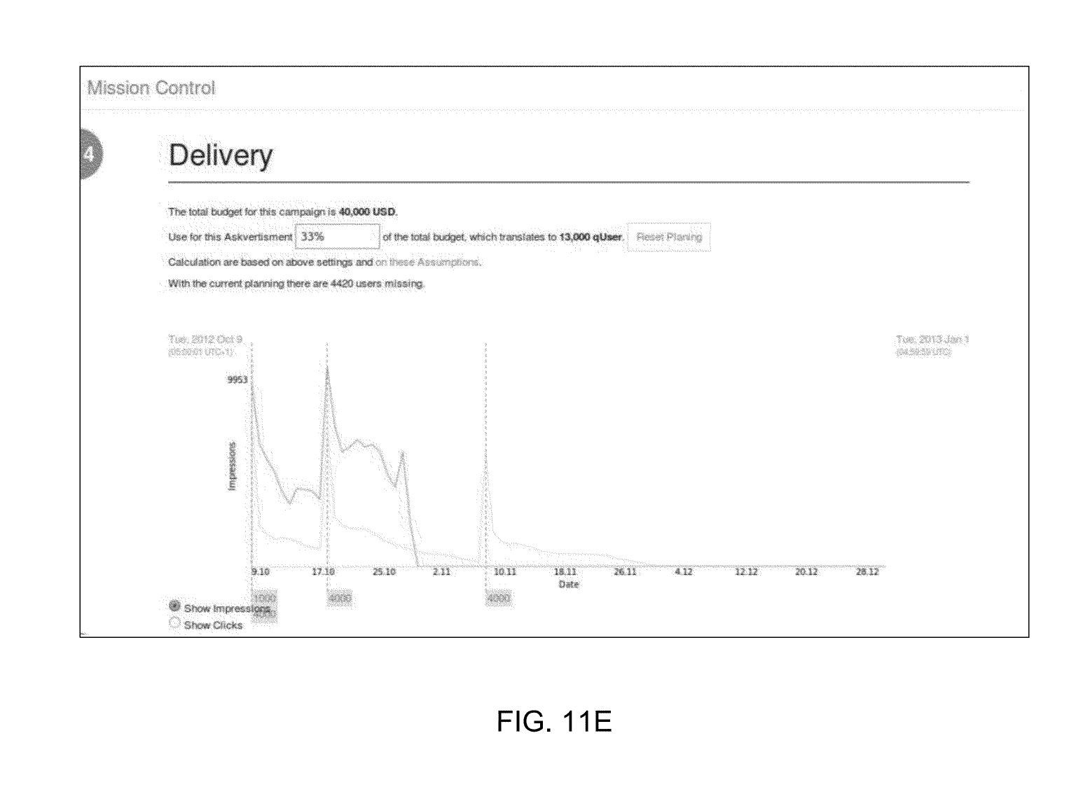

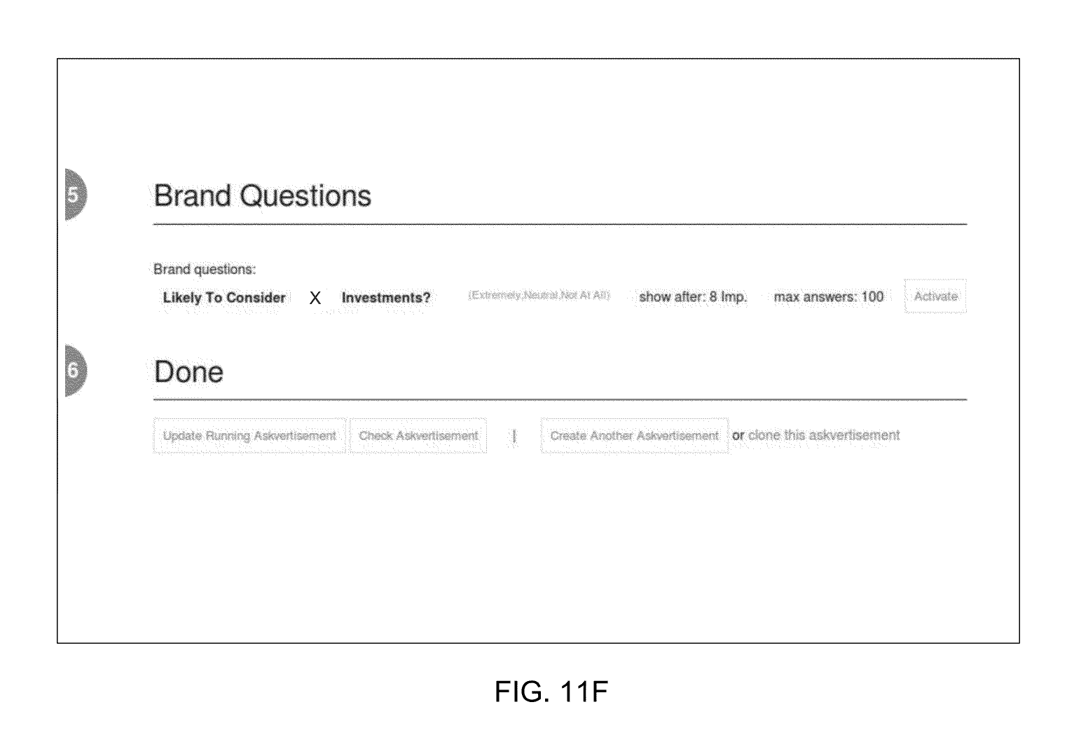

Referring to FIGS. 11A to 11F, these example screen shots generally illustrate an example form used to create new questions including a brand question.

As illustrated in FIG. 11A, in this example, information processing system 302 displays a plurality of information and buttons including selectable campaigns A, B, C and D. In this example, in response to a selection of campaign A, information processing system 302 displays a detailed view for the selected campaign A, as shown in FIG. 11B.

As illustrated in FIG. 11B, information processing system 302 displays a plurality of information and buttons including create askvertisement button 1102. In this example, in response to a selection of askvertisement button 1102, information processing system 302 displays a form which includes a plurality of portions or sections which enables a user to operate with an input device to create questions and manage the settings of the questions, as illustrated in FIGS. 11C to 11F.

Referring to FIG. 11C, in this example, information processing system 302 displays a form which includes a first section labeled “Details” which enables a user to set the billing type, the price per unit, the operating system, the location and the top level advertiser domain.

Information processing system 302 also displays a second section labeled “Question and Answer Options” which enables a user to set or manage the question, the answer options, the tracking Url and the block settings.

Referring to FIG. 11D, information processing system 302 displays a third section labeled “Creatives” which enables a user to set or manage options associated with each creative.

Referring to FIG. 11E, information processing system 302 displays a fourth section labeled “Delivery” which enables a user to plan when a question will be asked, including an intelligent design forecast.

Referring to FIG. 11F, information processing system 302 displays a fifth section labeled “Brand Questions” and a sixth section labeled “Done”. In this example, the brand question “Likely to Consider X Investments” enables a measurement to a change in sentiment/purchase intent/brand awareness. For example, after a predetermined number of ads have been displayed to a user, a brand question may be presented to the user. This brand question may also be presented to a control group.

In some embodiments, the user (e.g., an Advertising Agency) is responsible for setting or developing a media plan which may include any of the following: the time frame of the campaign; the volume of the questions and how the questions will be exposed to users in terms of frequency of exposures to users; where users are located geographically; what media device (e.g., a Personal Computer, Tablet, or mobile phone) users may own; what time of day it is when users are exposed to questions; what category of application or other media (e.g., a Web site or Mobile Site or pages therein) that users are consuming when he or she is exposed to a question.

In some embodiments, the user (e.g., an Advertising Agency) may filter their questions by selecting the demographic attributes of users that are exposed to questions and advertisements. These attributes may include age, gender, education and income.

In some embodiments, a user (e.g., a supplier) may deliver recommendations with respect to questions to another user (e.g., an Advertising Agency). These recommendations may include any of the following: question format, semantic structure, grammar, lexicon, style and sentence length. These recommendations may be based on the user's (Advertising Agency's) objectives. Brand owner objectives fall into two broad categories; brand awareness and Sales. The recommendations made to a client with brand awareness objectives will be distinct from those made to users with sales objectives. Recommendations regarding the advertising creative that follows the exposure of a question that a user's objectives may be made. If a user's advertisement creative offers an end user a logical message that the end user can unequivocally connect with the prior question, then the probabilities objectives will be met rise substantially.

In some embodiments, information processing system 302 determines whether to cause a mobile device to display the advertisement data representative of an advertisement in a window. In some embodiments, the determination to cause the mobile device to display the advertisement data representative of an advertisement is determined based on a location of the mobile device, determined based on the type of mobile device, determined based on the operating system of the mobile device, determined based on the version of the operating system of the mobile device, determined based on a unique identifier of the mobile device (e.g., a Unique Device Identifier), determined based on time, determined based on a time zone, determined based on language, determined based on content (e.g., an application, an application category, a website URL, etc.), determined based on keywords describing content, determined based on a partner ID, determined based on the available space to display the question, determined based on a user agent, determined based on the availability of advertisements, determined based on answer data associated with or corresponding to a user of the mobile device or determined based on any other suitable method or criteria.

In some embodiments, information processing system 302 determines or selects advertisement data representative of at least one advertisement to be displayed. In some embodiments, the determination of which advertisement data representative of at least one advertisement to be displayed is determined based on a location of the mobile device, determined based on the type of mobile device, determined based on the operating system of the mobile device, determined based on the version of the operating system of the mobile device, a unique identifier of the mobile device (e.g., a Unique Device Identifier), determined based on time, determined based on a time zone, determined based on language, determined based on content (e.g., an application, an application category, a website URL, etc.), determined based on keywords describing content, determined based on a partner ID, determined based on the available space to display the question, determined based on a user agent determined based on the availability of advertisements, determined based on answer data associated with or corresponding to a user of the mobile device or determined based on any other suitable method or criteria.

In some embodiments, the determination of which advertisement data representative of at least one advertisement to be displayed is determined based on answer data representative of an answer to a brand question. A brand question may measure a change in a consumer's sentiment, purchase intent and/or brand awareness. For example, after a consumer has seen a predetermined number of ads, the mobile device may display the following brand question: “Likely to consider an investment from Company A?” In this example, information processing system 302 may determine or select advertisement data representative of at least one advertisement to be displayed based on received answer data representative of an answer to the brand question “Likely to consider an investment from Company A?”

In some embodiments, the determination of when to display a brand question is based on a predetermined number of ads being displayed by the mobile device. For example, a brand question may not be displayed unless a predetermined number of ads have been displayed by the mobile device.

In some embodiments, information processing system 302 determines when to cause a mobile device to display the advertisement data representative of an advertisement in a window. In some embodiments, the determination of when to cause the mobile device to display the advertisement data representative of an advertisement is determined based on a location of the mobile device, determined based on the type of mobile device, determined based on the operating system of the mobile device, determined based on the version of the operating system of the mobile device, a unique identifier of the mobile device (e.g., a Unique Device Identifier), determined based on time, determined based on a time zone, determined based on language, determined based on content (e.g., an application, an application category, a website URL, etc.), determined based on keywords describing content, determined based on a partner ID, determined based on the available space to display the question, determined based on a user agent, determined based on the availability of advertisements, determined based on answer data associated with or corresponding to a user of the mobile device or determined based on any other suitable method or criteria.

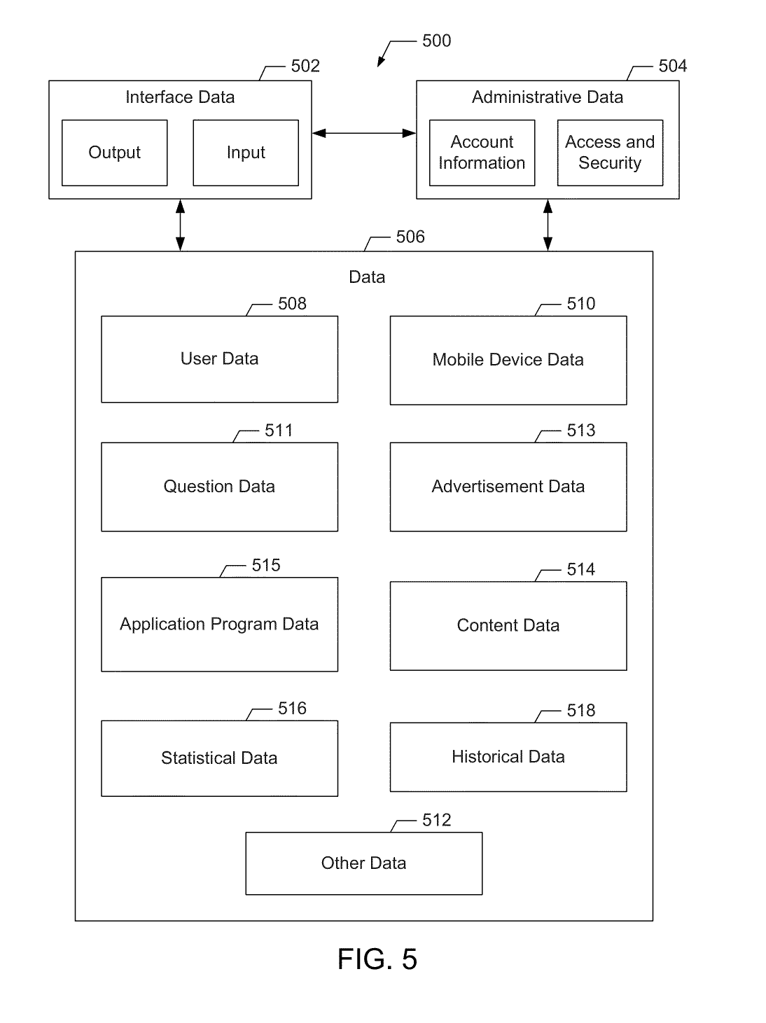

FIG. 5 is a block diagram of an example data architecture 500. In this example, data interface data 502, administrative data 504, and data 506 interact with each other, for example, based on user commands or requests. The interface data 502, administrative data 504, and data 506 may be stored on any suitable storage medium (e.g., database system 310 and/or server 226). It should be appreciated that different types of data may use different data formats, storage mechanisms, etc. Further, various applications may be associated with processing interface data 502, administrative data 504, and data 506. Various other or different types of data may be included in the example data architecture 500.

Interface data 502 may include input and output data of various kinds. For example, input data may include mouse click data, scrolling data, hover data, keyboard data, touch screen data, voice recognition data, etc., while output data may include image data, text data, video data, audio data, etc. Interface data 502 may include formatting, user interface options, links or access to other websites or applications, and the like. Interface data 502 may include applications used to provide or monitor interface activities and handle input and output data.

Administrative data 504 may include data and applications regarding user accounts. For example, administrative data 504 may include information used for updating accounts, such as creating or modifying user accounts and/or host accounts. Further, administrative data 504 may include access data and/or security data. Administrative data 504 may include a terms of service agreement. Administrative data 504 may interact with interface data in various manners, providing mobile device 304 with administrative features, such as implementing a user login and the like.

Data 506 may include, for example, user data 508, mobile device data 510, question data 511, other data 512, advertisement data 513, content data 514, application program data 515, statistical data 516, and/or historical data 518.

User data 508 may include at least one data representative of: the gender of the user of the mobile device; answers to questions previously displayed by the mobile device of the user; advertisements which have already been displayed by the user's mobile device; advertisements which have already been clicked by the user of the mobile device; and other user profile data discussed herein.

Mobile device data 510 may include at least one of data representative of: the location of the mobile device; the type of mobile device; the operating system of the mobile device; the version of the operating system of the mobile device; the unique identifier of the mobile device; the language employed by the mobile device; the available space to display a question; and a user agent.

Question data 511 may include a wide variety of one of more questions (e.g., the specific questions recited herein) which may be displayed by mobile device 302 and question fields. Question data 511 may include data representative of at least one brand question.

Other data 512 may include data representative of: inventory data including advertisement inventory data and question inventory data; time zones; answer fields; answer data; answer choice data; drop down menus; campaign title data; map data; an amount of questions displayed; an amount of advertisements displayed; time meters; databases; programs; files; libraries; pricing data; operations data; tagging data; display interface buttons including a slider; and/or usage data.

Advertisement data 511 may include a wide variety of one of more advertisements which may be displayed by mobile device 302.

Content data 514 may include any suitable content such as audio data, video data image data.

Application program data 515 may include applications which may be downloaded or requested by a mobile device. Applications may be designed to help a user to perform specific tasks. Applications may include enterprise software, accounting software, office suites, graphics software and media players.

Statistical data 516 may include data used for providing reports including graphs, forecasts, recommendations, calculators, depreciation schedules, tax information, etc., including equations and other data used for statistical analysis.

Historical data 518 may include past data representative of: answers to questions previously displayed by the mobile device of the user; advertisements which have already been displayed by the user's mobile device; advertisements which have already been clicked by the user of the mobile device

It should be appreciated that data may fall under one or more categories of automobile market data 506, and/or change with the passage of time.

It should be appreciated that a system administrator may load data 506 into the information processing system 302 as it becomes available. It should also be appreciated that data 506 may be tailored for a particular information processing system, for example, a publisher may request that a specific type of data that is not normally stored or used be stored in the database system 310. Accordingly, for example, customized reports may be provided to publishers using that specific data.

Data 506 may be maintained in various servers 108, in databases or other files. It should be appreciated that, for example, a host device 104 may manipulate data 506 in accordance with the administrative data 504 and interface data 502 to provide requests or reports to users 114 and perform other associated tasks.

It should be appreciated that the systems and methods disclosed herein may help inform an entity's mobile advertising strategy by serving questions for applications executed by mobile devices. For example, by asking questions in real-time for applications that are published by an application publishing entity, the application publishing entity may gain insights from the user's of the applications published by the application publishing entity. Further, by employing the system and/or methods described herein, an application publisher may profile their audience demographics and psychographics including their user's affinity towards purchasing decisions on items such as high-definition televisions, athletic gear and automobiles. Based on this insight, more relevant advertisements may be selected and displayed to users of mobile devices.

By replacing advertisements in mobile devices apps with customized engaging and relevant questions, the systems and methods disclosed herein may provide an indication of public opinion on any brand, topic or product.

In one example embodiment, the systems and methods disclosed herein may enable an entity to learn which features of an application are more important to users. Such knowledge may be valuable because often times an application developer can not create all features at once. The systems and methods disclosed herein may enable an entity to learn such information, by enabling the entity to ask customized questions to the users of designated applications.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
storing, on a computer readable medium, (a) question data representative of a question; (b) first advertisement data representative of a first advertisement; and (c) second advertisement data representative of a second advertisement;
transmitting, via an information processing system, to a mobile device having a window, the question data representative of the question,
for an application program, displaying, via the mobile device, the question in the window;
for the application program, receiving, from the mobile device, answer data representative of an answer to the question;
based on the answer data representative of the answer to the question, selecting, via the information processing system, one of: (a) the first advertisement data representative of the first advertisement; and (b) the second advertisement data representative of the second advertisement;
in response to the first advertisement data being selected:
(a) transmitting, via the information processing system, to the mobile device, the first advertisement data representative of the first advertisement; and
(b) for the application program, displaying, via the mobile device, the first advertisement in a second window of the mobile device; and
in response to the second advertisement data being selected:
(a) transmitting, via the information processing system, to the mobile device, the second advertisement data representative of the second advertisement; and
(b) the mobile device being configured to device, for the application program, displaying, via the mobile device, the second advertisement in the second window of the mobile.

2. An information processing system comprising:
a processor; and
a memory device operatively coupled to the processor, the memory device storing: (a) question data representative of a question; (b) first advertisement data representative of a first advertisement; (c) second advertisement data representative of a second advertisement; and (d) instructions which when executed by the processor, cause the processor to:
(a) transmit, to a mobile device, the question data representative of the question, the mobile device being configured to, for an application program, display the question in a window of the mobile device;
(b) receive, from the mobile device, answer data representative of an answer to the question;
(c) based on the answer data representative of the answer to the question, select one of:
(i) the first advertisement data representative of the first advertisement; and
(ii) the second advertisement data representative of the second advertisement;
(d) in response to the first advertisement data being selected, transmit, to the mobile device, the first advertisement data representative of the first advertisement, the mobile device being configured to, for the application program, display the first advertisement in a second window of the mobile device; and
(e) in response to the second advertisement data being selected, transmit, to the mobile device, the second advertisement data representative of the second advertisement, the mobile device being configured to, for the application program, display the second advertisement in the second window of the mobile.

3. The information processing system of claim 2, wherein the question data representative of the question includes question data representative of a single question.

4. The information processing system of claim 2, wherein the question data representative of the question includes question data representative of a brand question.

5. The information processing system of claim 2, wherein the instructions, when executed by the processor, cause the processor to enable a user to customize answer choice data for the question.

6. The information processing system of claim 2, wherein the instructions, when executed by the processor, cause the processor to embed a question module into the application program.

7. The information processing system of claim 2, wherein the second window is different from the first window.

8. The information processing system of claim 2, wherein the instructions, when executed by the processor, cause the processor to determine data representative of at least one of:
(a) an amount of questions displayed by the mobile device;
(b) an amount of questions answered;
(c) an amount of advertisements displayed by the mobile device; and
(d) an amount of advertisements selected.

9. The information processing system of claim 8, wherein the instructions, when executed by the processor, cause the processor to display the determined data.

10. The information processing system of claim 2, wherein the instructions, when executed by the processor, cause the processor to enable a user to change the question to a second different, question.

11. The information processing system of claim 2, wherein the instructions, when executed by the processor, cause the processor to determine which question to transmit to the mobile device based on the type of mobile device.

12. The information processing system of claim 2, wherein the instructions, when executed by the processor, cause the processor to determine which question to transmit to the mobile device based on an answer to a previously displayed question.

13. The information processing system of claim 2, wherein the instructions, when executed by the processor, cause the processor to determine which question to transmit to the mobile device based on a user profile which is associated with a user of the mobile device.

14. A mobile device comprising:
a processor;
an input device operatively coupled to the processor;
a display device operatively coupled to the processor;
a memory device storing instructions which executed by the processor, cause the processor to:
(a) receive, from an information processing system, question data representative of a question;
(b) for an application program, cause the display device to display the question in a first window;
(c) enable a user to operate the input device to answer the question;
(d) transmit, to the information processing system, answer data representative of an answer to the question;
(e) receive, from the information processing system, advertisement data representative of an advertisement, the advertisement data being selected based on the answer data representative of an answer to the question; and
(f) cause the display device to display the advertisement in a second window.

15. The mobile device of claim 14, wherein the question data representative of the question includes question data representative of a single question.

16. The mobile device of claim 14, wherein the question data representative of the question includes question data representative of a brand question.

17. The mobile device of claim 14, wherein the instructions, when executed by the processor, cause the processor to enable a user to answer the question based on a touch gesture.

18. The mobile device of claim 17, wherein the touch gesture includes moving a slider to one a plurality or displayed answer choices.

19. The mobile device of claim 17, wherein the touch gesture includes selecting one of a plurality of displayed answer choices.

20. The mobile device of claim 14, wherein the instructions, when executed by the processor, cause the processor to enable a user to answer the question based on a physical gesture.

21. The mobile device of claim 20, wherein the physical gesture includes shaking the mobile device.

22. The mobile device of claim 14, wherein the instructions, when executed by the processor, cause the processor to enable a user to answer the question by selecting one of a plurality of displayed answer choices.
